(19) United States
(12) Patent Application Publication
(10) Pub. No.: US 2009/0086946 A1
(43) Pub. Date: Apr. 2, 2009

(54) METHOD FOR OPERATING A TELEPHONE SYSTEM AND TELEPHONE SYSTEM FOR CARRYING OUT THE METHOD

(75) Inventor: Marc FRIEBEL, Hosbach (DE)

Correspondence Address: SHERIDAN ROSS P.C., 1560 BROADWAY, SUITE 1200, DENVER, CO, 80202, US

(73) Assignee: AVAYA GMBH & CO. KG, Frankfurt am Main (DE)

(21) Appl. No.: 12/119,348

(22) Filed: May 12, 2008

(30) Foreign Application Priority Data
Aug. 7, 2007 (EP) 07015549.4

(51) Int. Cl. H04M 3/42

(52) U.S. Cl. 379/201.12

(57) ABSTRACT

A method for operating a telephone system with at least one telephony terminal to which and/or from which, in addition to voice data or user data, functional data are transmitted by means of which special functions of the telephone system are carried out, shall enable a management of the incoming information of the calling party, which can be handled in a particularly favorable way, even in case of a relatively complex structure of the system and the calling parties. For this purpose, according to the invention, a calling party is offered, as a special function, the option to edit his telephone number stored in a list of telephone numbers of the telephony terminal.

### FIELD

The invention relates to a method for operating a telephone system with at least one telephony terminal to which and/or from which, in addition to voice data or user data, functional data are transmitted by means of which special functions of the telephone system are carried out. It also relates to a telephone system, in particular for carrying out the method, with at least one telephony terminal to which and/or from which, in addition to voice data or user data, functional data are transmitted by means of which special functions of the telephone system are carried out.

### BACKGROUND

In modern telephone installations or systems, usually a plurality of telephony terminals are connected with a central exchange unit, via which telecommunication connections are established between individual telephony terminals or also of calls coming in from outside the internal telephone network with selected telephony terminals. Within the framework of these telecommunication connections, voice data or user data are transmitted to the respective selected telephony terminal and/or from the latter to the central exchange unit and from the central exchange unit to the respective terminal. The data can be transmitted in the conventional manner or else using the Internet protocol.

Usually in such telephone installations or systems, in addition to the voice data or user data to and/or from the respective telephony terminals, further data, namely so-called functional or control data, are transmitted, which are not a direct part of the information exchanged within the communication connection, but form the foundation for carrying out so-called special functions of the telephone system. Such special functions can be, for example, setting-up or control data for activating or deactivating call forwarding operations, functions of answering machines, call charge registration or management information or the like. Alternatively, it is also possible within the framework of such special functions to transmit the telephone number or extension number of the calling party to the respective called telephony terminal and to display it there, so that the user of the called telephony terminal can get information about the calling party already at the moment when the call is coming in. If the called party is absent, telephone numbers of the calling parties can also be stored in a list of telephone numbers or calling parties of the called telephony terminal, within the framework of further special function, so that the called party after his return to his work place, is informed about the calls that have come in, in the meantime and were not taken by him.

Especially in relatively complex telephone installations or systems, such as, for example, in call centers or the like, or in telephone systems in enterprises or organizational units, where the called telephony terminal is not necessarily selected because of the person of the respective user, but because of the latter's subject-matter qualification or competence, such a system of systematic storing of information of the calling party in the respective called telephony terminal may, however, lead to a storage of relatively large data quantities which make it difficult or completely impossible to work off the information at a later time or to manage the callbacks specifically and according to requirements.

### SUMMARY

Therefore, the invention is based on the task to provide a method for a telephone system of the above-described type, enabling a particularly favorably handleable management of the incoming calling-party information even with a relatively complex structure of the system and the calling parties. Furthermore, a telephone system shall be provided which is particularly suitable for carrying out the method.

Regarding the method, this task is solved according to the invention by offering, as a special function, a calling party the option to edit his telephone number stored in a telephone-number list of the telephony terminal.

The invention is based on the consideration that, especially with relatively complex telephone systems or also possible calling-party structures, a simplification and thus also an easier handling of the information stored in telephone-number lists in individual telephony terminals is possible by selecting and managing this information in a manner particularly adapted to the requirements. For this purpose, the possibility should in particular be provided to access calling-party information even after their storage in the telephone-number lists of the called telephony terminal, in order to provide or to complete them, if necessary, with further additional information facilitating a subsequent information management. It should in particular be taken into account that especially the reactions caused or intended by the storage in telephone-number lists in the called telephony terminal consist in particular in a request for being called back or in a callback. Especially from the point of view of the calling party, whose telephone number is stored in such a telephone-number list, this request for being called back may, however, be dropped or modified immediately or also at a later time. Thus, a management of the information stored in the telephone-number lists is possible in a manner particularly adapted to the requirements, by giving the calling party the possibility to suitably store relevant additional information. For this purpose, an option should be provided as a special function enabling the calling party to access scope and type of the telephone number stored for him in the telephone-number list.

Advantageously, the calling-party list of the telephony terminal is provided as the telephone-number list. In such an embodiment, the calling party is offered the option, as a special function, to subsequently access the entry concerning him in the calling-party list of the called telephony terminal.

In a particularly advantageous embodiment of this special function, i.e. the option of subsequent access to the information stored for the calling party in the calling-party or telephone-number list of the called telephony terminal, it is taken into account that such an entry in the telephone-number or calling-party list of the called telephony terminal is usually associated by the user of this terminal with a request of the calling party to be called back. Therefore, the possibility of the calling party's access to the entry stored for him in the telephone-number list of the called telephony terminal is in a particularly advantageous embodiment aimed at storing additional information in view of a possibly desired callback. In an advantageous embodiment, it can be provided that the calling party is offered the option to complete the telephone-number entry in the calling-party list by a status information stating whether or not a recall is requested. In another or alternative advantageous embodiment, the stored telephone-number entry is, furthermore, completed by detailed, preferably editable, information, for example from which time or until which time at the latest, a callback is requested.

In a particularly advantageous embodiment, especially in view of possibly relatively complex telephone installations or systems, it is, however, provided to consistently streamline and minimize the information stored in the telephony terminal in the form of telephone-number or calling-party lists. For this purpose, the calling party is advantageously offered the option to delete his telephone number stored in the telephone-number list of the telephony terminal from the telephone-number list. In this way, it is guaranteed that at least those callbacks and the like which are recognizably no longer necessary are immediately removed from the corresponding storage area of the telephony terminal, so that the total data quantity to be taken notice of and, if necessary, to be verified by the user of the telephony terminal is kept particularly small.

Advantageously, the calling party is offered the option to edit his entry in the telephone-number list after a requested connection with the telephony terminal did not materialize. This takes into account in particular the fact that the entry in the telephone-number or calling-party list is possibly only made if the requested connection did not materialize.

The editing of the telephone number from the telephone-number list could be caused and initiated by a central exchange unit of the telephone system or by another suitable device, the calling party being offered in particular the option, in the manner of an entry or prompting menu, through specific inquiries, to edit after the calling attempt the corresponding entry in the telephone-number list of the called telephony terminal. In a particularly advantageous embodiment, the editing of the telephone number from the telephone-number list is, however, caused by the telephony terminal of the calling party. Thus, in such an embodiment, the calling party has the possibility, at any time after the failed calling attempt, i.e. both immediately after the call and at a later time, to suitably edit his corresponding entry telephone-number list. In this way, one can in particular take into account the possibility that first of all, the calling party wanted to be called back, but afterwards this wish was dropped, for example because his inquiry was settled in the meantime by another department.

A particularly reliable and varied transmission of functional data in combination with voice data or user data can be achieved by advantageously transmitting the before-mentioned data using the Internet protocol, by which the voice signals are advantageously compressed and digitized and transmitted to the other party of the call in the form of voice packets using an Internet protocol. As an Internet protocol for voice transmission, the SIP (Session Initiation Protocol) standard is imaginable, but preferably, the H.323 standard is used.

Regarding the telephone system, the above-mentioned task is solved by providing as a special function to offer a calling party an option to edit his telephone number stored in a telephone-number list of the telephony terminal. Advantageously, the telephone system is designed for also carrying out the above-mentioned advantageous embodiments of the method.

The advantages achieved with the invention consist in particular in the fact that by offering the calling party an option to subsequently edit his telephone number stored in the telephone-number list of the telephony terminal, in particular after a failed calling attempt, it is possible to manage the information stored in the called telephony terminal in a way particularly adapted to the requirements. Especially in relatively complex system structures or also calling-party structures, this makes it possible to select and structure the data stored, making it easier for the user of the called telephony terminal to handle any callback requests that have come in, upon return to his work place. A handling particularly adapted to the requirements, of the information in the telephone-number list of the called telephony terminal is guaranteed in particular by granting the calling party himself subsequent access to the telephone number identifying him, because it is exactly the calling party himself who as a rule possesses up-to-date information regarding his callback request, which, thanks to the access granted, he can communicate to the party called and not reached.

### BRIEF DESCRIPTION OF THE DRAWINGS

FIG. 1 is a schematic representation of a telephone system, in accordance with embodiments of the present invention.

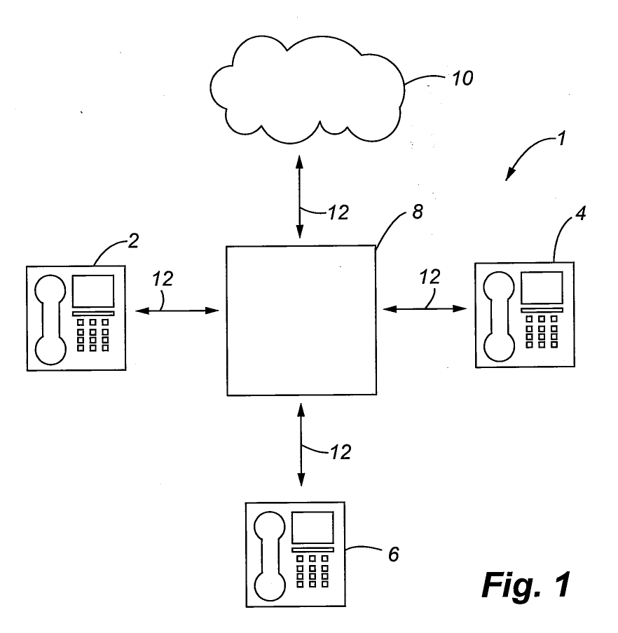

### DETAILED DESCRIPTION

The telephone system 1 according to the FIGURE comprises a number of telephony terminals 2,4,6, connected on the data side by a common central exchange unit 8, also designated as PBX. The central exchange unit 8, in turn, is connected with an external telephone network 10. In the exemplary embodiment, the Internet protocol is provided as the transmission medium, the central exchange unit 8 being suitable connected via the Internet with the telephone network 10.

As indicated by the double arrows 12, the central exchange unit 8 is connected via suitable data or communication channels both with the external telephone network 10 and with the internal telephony terminals 2,4,6. In operation of the telephone system 1, on the one hand voice data or user data are exchanged with the telephony terminals 2,4,6, which are exchanged in a suitable compressed and digitized form, in view of the utilization of the Internet protocol provided in the exemplary embodiment. In addition to the voice data or user data, however, functional data too, are transmitted via the above-mentioned communication channels, by means of which special functions of the telephone system 1 are carried out. As special functions, the exemplary embodiment provides, in a quite usual design, in particular functions which can be activated by the individual users, such as, for example, call forwarding operations, functions of answering machines, call charge management or the like.

In addition, the telephone system 1 provides as a further special function that in the individual telephony terminals 2,4,6, in the manner of a calling-party list, a telephone-number list of the telephone numbers of those calling parties is created whose call could not be taken at the respective telephony terminal 2,4, or 6. The telephone numbers of these calling parties are stored in the before-mentioned telephone number list in the respective called telephony terminal 2,4 or 6, possibly adding additional information, such as hour of call or the like, and can afterwards be fetched by the user of the respective telephony terminal 2,4 or 6 by means of suitable command functions, such as, for example, function keys.

Furthermore, however, the telephone system 1 is designed to a particularly high degree for enabling a further processing of the stored information in a manner particularly adapted to the requirements and in compliance with the aims of the respective user, even in relatively complex telephone networks or also complex calling-party structures. To achieve this, the telephone system 1 is specifically designed for the possibility that a calling party whose incoming call could not be taken on one of the telephony terminals 2,4, or 6, respectively, and whose telephone number was, therefore, sorted in the corresponding list of telephone numbers, can subsequently access and edit this entry in the respective called telephony terminal 2, 4, or 6. This option is provided by the telephone system 1 as a further special function for all calling parties, in particular for parties calling from internal telephony terminals 2,4,6 but also—as far as this is possible in view of the mechanisms and components available in the external telephone network 10—from the external telephone network 10. In operation of the telephone system 1, a calling party, upon whose calling attempt a communication connection with the selected telephony terminal 2,4,6 did not materialize, is offered the above-mentioned option of editing his telephone-number entry. This editing is caused in the telephone system 1 from the calling party's telephony terminal, so that the calling party can edit his telephone-number entry accordingly either immediately after his calling attempt or else after a certain waiting period.

When editing the telephone-number entry, the latter can in particular be provided with additional information specifying whether a callback by the called party is desired and if so, under which conditions, i.e., for example, from which time at the earliest or until which time at the latest. Alternatively, however, it can also be provided that the calling party subsequently deletes his corresponding telephone-number entry in the respective telephony terminal 2,4,6 so that no information about his calling attempt is stored there. Especially this option of deletion can guarantee even in complex telephone systems that the called and temporarily not available party will find a data quantity or telephone-number list which is particularly small and adapted to the requirements, when he returns to his work place. It can in particular be taken into account that a callback request exists first of all, but is subsequently deleted, for example if the calling party has received a desired information from an employee other than the one originally called.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

It is to be noted that the term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

### LIST OF REFERENCE NUMBERS

1 Telephone system
2,4,6 Telephone terminal
8 Exchange unit
10 Telephone network
12 Double arrows

What is claimed is:

1. A method for operating a telephone system having at least one telephony terminal, comprising:
in addition to voice data or user data, transmitting functional data to/from the at least one telephone terminal; and
in response to transmitting functional data, carrying out special functions of the telephone system, including offering a calling party, as a special function, an option to edit his telephone number stored in a list of telephone numbers associated with the telephony terminal.

2. A method according to claim 1, wherein the list of calling parties associated with the telephony terminal is provided as the list of telephone numbers.

3. The method according to claim 1, wherein the calling party is offered the option to delete his telephone number from the list of telephone numbers associated with the telephony terminal.

4. The method according to claim 1, wherein the calling party is offered the option to edit his telephone number, after an unsuccessful attempt to connect with the telephony terminal.

5. The method according to claim 1, wherein the option to edit the telephone number stored in the list of calling parties is occasioned by a telephony terminal associated with the calling party.

6. The method according to claim 1, wherein the voice data, user and/or functional data are transmitted using the Internet protocol.

7. A telephone system having at least one telephony terminal to which and/or from which, in addition to voice data or user data, functional data can be transmitted by means of which special functions of the telephone system are carried out, wherein a particular special function includes an option for a calling party to edit his telephone number stored in a list of telephone numbers associated with the telephony terminal.
